(19) United States
(12) Patent Application Publication
(10) Pub. No.: US 2018/0328568 A1
(43) Pub. Date: Nov. 15, 2018

(54) Let It Shine Decorative Electric Lamps

(71) Applicant: Luis Mejia, Santa Rosa Valley, CA (US)

(72) Inventor: Luis Mejia, Santa Rosa Valley, CA (US)

(21) Appl. No.: 15/979,363

(22) Filed: May 14, 2018

Related U.S. Application Data
(60) Provisional application No. 62/505,750, filed on May 12, 2017.

(51) Int. Cl. F21V 3/04; F21S 6/00; F21V 3/06; F21V 9/08; F21V 23/04

(52) U.S. Cl. CPC F21V 3/049; F21S 6/002; F21V 23/04; F21V 9/08; F21V 3/0625

(57) ABSTRACT

A decorative, atmospheric lamp or mood lamp, creatively and expertly crafted out of PVC pipe in a variety of designs and motifs, and intended for use with a variety of colored light bulbs, including light bulb that emit white light.

### CLAIM OF PRIORITY

This patent application claims priority under 35 USC 119 (e) (1) from U.S. Provisional Patent Application Ser. No. 62/505,750 filed May 12, 2017, of common inventorship herewith entitled, “Let It Shine Electric Lamps,” which is incorporated herein by reference as though the same were set forth in its entirety

### FIELD OF THE INVENTION

The present invention pertains to the field of electric lamps, and more specifically to the field of decorative, atmospheric lamps or mood lamps, creatively and expertly crafted out of PVC pipe in a variety of designs and motifs, and intended for use with a variety of white or colored lightbulbs.

### BACKGROUND OF THE INVENTION

Everyone needs interior electric lights and lamps, whether in homes or offices, motel rooms, or even hospital rooms. Strictly speaking, there are two broad categories of lamps: those that provide illumination for work area such as a desk, a room, or part of a room, and which may be used for reading or any number of other activities; and those that provide atmospheric lighting, or mood lighting. Both types of lamps may be objects of beauty and good design in themselves; but the mood lamp is quite different from a floor lamp or desk lamp, as its primary purpose is to set a mood or atmosphere, rather than to provide usable illumination. The present invention provides a product line of mood lamps, expertly crafted from a common but surprising material—one not associated in our minds with lighting, but instead with plumbing. Once seen as a lamp, however, the material from which it is made becomes irrelevant, and in fact is overwhelmed by the beauty of the lamp and the atmospheric lighting it provides.

The prior art has put forth several designs for lighting. Among these are:

U.S. Pat. No. 7,314,293 to Frederick Steier et al provides a lamp including a holder having a base with a plurality of vertical walls extending upwardly therefrom. A window is formed in at least one of the walls. A panel, including an image, is removably disposed adjacent to the window. The panel is illuminated to highlight the image and create a desired effect.

U.S. Pat. No. 8,596,833 to Daniel Cytrynowicz provides an interchangeable lamp shade kit comprising a lamp base, a spider element and a shade element with at least flat and deployed confirmations. The shade element includes opposing first and second ends with respective securement elements generally formed thereat and adapted to engage one another for releasably retaining the shade element in its cylindrical deployed configuration. A plurality of detent apertures in the shade element are adapted to receive respective detent elements radially distributed about the spider element. An exemplary system and method for displaying lamp shade kits may comprise a display element supportingly presenting a multiplicity of lamp bases, a plurality of spider elements, and an assortment of shade elements. The shade elements may be releasably suspended in their flat configurations in a linear or curved array for convenient review and selection by consumers positioned on a consumer pathway adjacent the display element.

U.S. Pat. No. 6,736,530 to Alex J. Thevenot provides an illuminating picture lamp providing means by which images may be illuminated by a light source on a selectable and removably attachable basis. Using a base layer of translucent material preferably circumscribed by a transparent material, an image may be slipped between the two layers and illuminated by a light source. The sheets are used to form a lampshade and are held in place about a light source, such as a light bulb, by supports threadably engaging a mounting base. The mounting base attaches to the lamp generally below the light bulb to provide stable support for the lampshade. The image display device of the present invention provides attractive and selectable means by which images may be illuminated by a light source and articles, such as lamp shades, may be decorated on a personalized basis.

None of these prior art references describe the present invention.

### SUMMARY OF THE INVENTION

It is an object of the present invention to provide a decorative, atmospheric lamp or mood lamp, creatively and expertly crafted out of PVC pipe in a variety of designs and motifs, and intended for use with a variety of colored light bulbs, including light bulb that emit white light.

### BRIEF DESCRIPTION OF THE DRAWINGS

FIG. 1 is a perspective view illustrating an electric lamp constructed in accordance with the present invention.

FIG. 2 is another perspective view illustrating a pair of the electric lamp, constructed in accordance with the present invention showing an alternative embodiment of a top border.

### DETAILED DESCRIPTION OF THE INVENTION

The present invention is a decorative electric lamp, also referred to as a Let It Shine electric lamp. The present invention provides a decorative, atmospheric lamp or mood lamp, creatively and expertly crafted out of PVC pipe in a variety of designs and motifs, and intended for use with a variety of colored lightbulbs.

Please refer to the drawings.

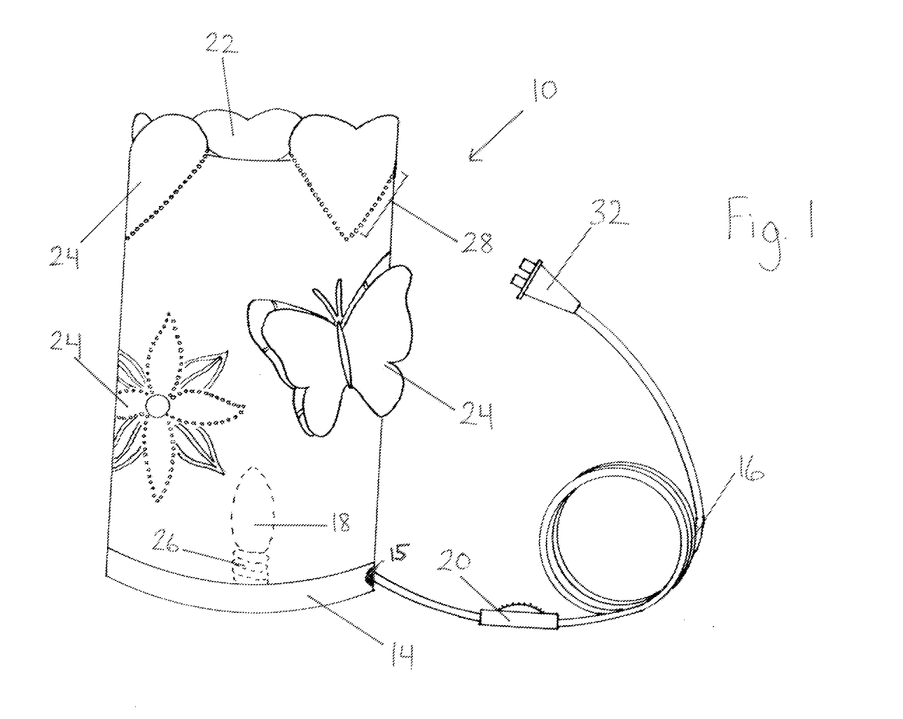

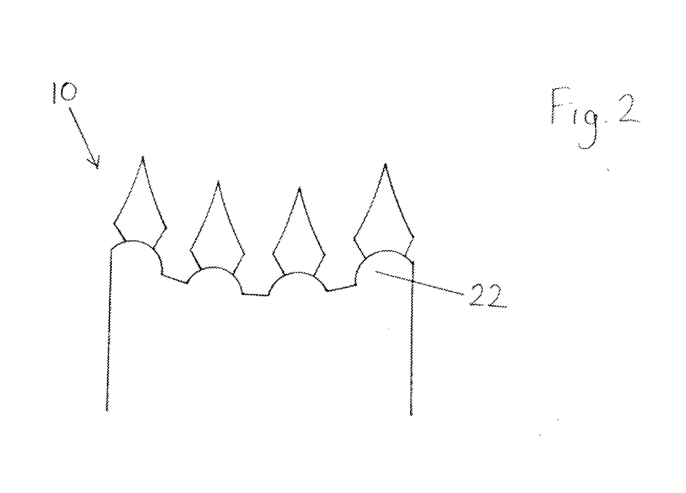

The lamp of the present invention is produced in PVC pipe, and is essentially cylindrical and has a flat bottom base designed to stand on a table top or other horizontal surface. In an embodiment, the diameter of the PVC pipe is approximately four (4) inches. In an embodiment, the height is approximately eleven (11) inches. The lamp 10 of the present invention is stable and sturdy, and features a circular base 14 having a hole 15 through which the electrical cord 16 runs. The light bulb fixture 18 within the lamp 10 is mounted to the base inside the lamp and comprises a standard, threaded socket 26, and the cord 16 is equipped with an in-line ON/OFF switch 20 and plug 32. Using a variety of fine tools, the PVC cylinders comprise patterned, scalloped or filigreed top borders 22. The lamp shown in FIG. 1 has a top border 22 composed of a series of heart shapes. The lamp shown in FIG. 2 has a top border 22 that resembles the fine work of a wrought-iron fence or gate. In addition, the lamp comprises a series of motifs 24 that range from hearts (shown in FIG. 1) to butterflies (shown in FIGS. 1 and 2) to flowers (shown in FIGS. 1 and 2). In an embodiment, these exquisitely turned-out motifs 24 are defined by a series of tiny perforations 28 in the pipe.

In an alternative embodiment, motifs comprise an external ornament comprising flower blooms, butterflies or other shapes attached to the outer surface of the PVC pipe, that appear to “float” above the surrounding surface of the cylinder. In this alternative embodiment the motif 24 is partially cut out of the PVC pipe and an external ornament is attached to the outer surface of the pipe adjacent to the cut out portion, by any suitable means, so that part of the cut out portion permits the egress of light. The various motifs and designs, as well as the surrounding PVC pipe, are presented in a variety of colors, so that the motifs and designs stand out in both line and color from the lamp 10.

Light is emitted not only from the open top 22 of the Let It Shine lamp 10, but also through the perforations 28 in the form of lines, holes, and spaces that allow the egress of light, thereby defining the blooms, butterflies, hearts, and other motifs 24. Thus, while the PVC pipe is itself opaque, the Let It Shine lamp puts out substantial mood-lighting; and with a variety of colored bulbs, i.e., green, red, blue, yellow, the Let It Shine lamp can be personally tailored by the user to set just the mood desired. The lamp can also employ white light, ivory light, pink light, or any softer shade light bulb to create a desired or calming effect.

One can easily envision the Let It Shine lamp in households, offices and reception areas, hotel and motel rooms, bathrooms, even in hospital and nursing-home rooms and common areas. The Let It Shine lamp enhances the atmosphere of almost any room in which it is placed. Eminently affordable, ready-to-use right out of the box, and designed to work with standard lightbulbs of any color, the Let It Shine lamp is exceptionally clever in conception, thoughtful in design, and first-class in craftsmanship and execution. Clearly, the Let It Shine lamp will find a wide and enthusiastic response in the household, commercial, and institutional markets.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A decorative lamp, comprising essentially cylindrical PVC pipe, having a flat bottom base designed to stand on a table top or other horizontal surface, comprising a circular base having a hole capable of receiving an electrical cord, further comprising a light bulb fixture mounted on the base inside the lamp, further wherein and the cord is equipped with an in-line ON/OFF switch and plug, further wherein, the PVC cylinder comprises scalloped, patterned or filigreed top borders; and further comprising at least one motif.

2. The lamp of claim 1 wherein the motif is defined by a series of tiny perforations in the PVC pipe.

3. The lamp of claim 1 wherein the motif is partially cut out of the PVC pipe creating a cut out portion and an external ornament is attached to the outer surface of the pipe adjacent to the cut out portion, so that part of the cut out portion permits the egress of light

4. The lamp of claim 2 manufactured in a variety of colors, so that the motifs and designs stand out in both line and color from the lamp.

5. The lamp of claim 3 manufactured in a variety of colors, so that the motifs and designs stand out in both line and color from the lamp.

6. The lamp of claim 2, wherein light is emitted from the open top of the lamp and light is emitted also through the perforations in the form of lines, holes, and spaces created by the motif that allows the egress of light, thereby defining the blooms, butterflies, hearts, and other motifs.

7. The lamp of claim 3, wherein light is emitted from the open top of the lamp and light is emitted also through the perforations in the form of lines, holes, and spaces created by the motif that allows the egress of light, thereby defining the blooms, butterflies, hearts, and other motifs.

8. The lamp of claim 2, wherein the lamp can also employs a variety of colored light bulbs including, but not limited to white light, ivory light, pink light, or any softer shade light bulb to create a desired or calming effect.

9. The lamp of claim 3, wherein the lamp can also employs a variety of colored light bulbs including, but not limited to white light, ivory light, pink light, or any softer shade light bulb to create a desired or calming effect.

10. The lamp of claim 2, wherein the diameter of the PVC pipe is approximately four (4) inches, and the height is approximately eleven (11) inches.

11. The lamp of claim 3, wherein the diameter of the PVC pipe is approximately four (4) inches, and the height is approximately eleven (11) inches.
